(19) United States
(12) Patent Application Publication
(10) Pub. No.: US 2012/0247190 A1
(43) Pub. Date: Oct. 4, 2012

(54) RHEOMETER

(75) Inventors: Stephen Brown, South Wales (GB); William Johns, Reading (GB); Richard Phillips, West Glamorgan (GB); Dale Rogers, South Wales (GB)

(73) Assignee: HAEMAFLOW LTD, Swansea (GB)

(21) Appl. No.: 13/504,520

(22) PCT Filed: Oct. 26, 2010
(86) PCT No.: PCT/GB10/51792

§ 371 Date: Jun. 14, 2012

(30) Foreign Application Priority Data
Oct. 28, 2009 (GB) 0918885.5

(51) Int. Cl. G01N 11/08

(52) U.S. Cl. 73/54.09

(57) ABSTRACT

A rheometeris disclosed for determining flow characteristics of a fluid. The rheometer comprises a circuit in which the fluid is arranged to flow. The circuit comprises a duct and a plurality of flow elements, each comprising a flow environment arranged in fluid communication with the duct. The flow environment of each element is arranged to convey fluid from an up-stream position to a downstream position of the respective flow element. The rheometer further comprises pressure sensing means arranged to determine fluid pressure at the upstream position and the downstream position of each of the plurality of flow elements. At least two of the plurality of flow elements comprise different flow environments for the fluid such that the rheometer can determine the flow characteristics of the fluid at a particular instant in time.

The present invention relates to a rheometer for determining flow characteristics of a fluid.

Rheometers are generally used to determine the flow characteristics of fluids which cannot be characterised with a single viscosity value. These so-called non-Newtonian fluids, which include lubricants, some paints, inks and blood comprise a viscosity, or more correctly an apparent viscosity, which is found to vary in dependence on the stress applied to the fluid. Non-Newtonian fluids may be characterized by so-called Constitutive Equations which relate stress and strain rate with, for some fluids, normal forces and/or elastic terms, in passing through a flow element. In contrast, Newtonian fluids can be characterized by a single value of viscosity that relates stress to strain rate at every point in the fluid. The apparent viscosity of a non-Newtonian fluid is thus the equivalent viscosity required of a Newtonian fluid in order to generate the same overall pressure drop at the same volumetric flow rate in passing through a flow element of the same geometry.

There are a number of non-Newtonian fluids which exhibit a further characteristic in that their constitutive equations vary with time. The apparent viscosity of these so-called gelling fluids generally increases with time and these fluids are found to eventually become solid. Examples of such gelling fluids are gelatine solutions and blood. The ability of blood viscosity to increase and thus clot is an important characteristic, since it can prevent haemorrhage, for example. However, it is also an important requirement that medical devices which are placed in the blood stream do not stimulate clotting.

Rheometers can be broadly grouped in two types in dependence of the type of stress that they apply to the fluid. These include shear rheometers which characterise the fluid in dependence of a shear stress and extensional rheometers which characterise the fluid in dependence of an extensional stress. However, the development of extensional rheometers has proceeded more slowly than shear rheometers due to the challenges associated with generating a homogenous extensional flow. The interaction of the test fluid with the fluid container of such rheometers is found to create a component of shear flow which acts to compromise the results, and the strain history of all the materials must be known and carefully controlled. As a result, the rheological properties of fluids are typically determined using shear rheometers.

There are currently two widely used approaches for assessing the rheological properties of fluids under shear. In the first approach, namely controlled stress rheometry, the fluid is held between two plates. One of the plates is rotated or oscillated and the force on the other plate is measured in determining the shear stress. By oscillating at a range of different rates or rotating at a range of different speeds a so-called flow curve can be generated which maps the apparent viscosity of the fluid with stress and strain. In the alternative approach, the fluid is passed through a capillary tube of precisely known dimensions and one of the flow rate or pressure drop across the tube is fixed and the other measured. Since the dimensions are precisely known, then either the measured flow rate can be used to determine the shear rate, or the pressure drop can be used to determine the shear stress. The flow curve can then be generated by varying the pressure drop or flow rate.

Controlled stress rheometers suffer the disadvantage however, that it can be difficult to establish flow characteristics from oscillating rheometer results. The analysis is further complicated by the fact that many non-Newtonian fluids, such as blood, are not homogeneous; it is found that blood develops a radial stratification on passing through blood vessels and tubes. Such stratification affects the rheological properties such that the flow characteristics of a fluid derived in one type of rheometer may not be consistent with the flow characteristics in another rheometer. It is also difficult to predict the flow of non-homogeneous fluids through complex flow paths.

Capillary rheometers suffer the disadvantage that they cannot be used to determine the flow characteristics of fluids that gel or become solid. Thus, in order to develop a flow curve for such a fluid, it is necessary to perform a series of runs in which fluid is passed through a capillary at different rates. If however, during the runs, the fluid begins to gel, then it is not possible to determine the flow characteristics at a point in time, nor as a function of time. This is because between each run, the capillary and associated components would need to be thoroughly cleaned to avoid earlier measurements affecting later measurements.

We have now devised an improved rheometer.

In accordance with the present invention as seen from a first aspect, there is provided a rheometer for determining flow characteristics of a fluid, the rheometer comprising a circuit in which the fluid is arranged to flow, the circuit comprising a duct and a plurality of flow elements,
each of the plurality of flow elements comprising a flow environment arranged in fluid communication with the duct, each flow environment being arranged to convey fluid from an upstream position to a downstream position of the respective flow element,
the rheometer further comprising pressure sensing means arranged to determine fluid pressure at the upstream position and the downstream position of each of the plurality of flow elements, wherein,
at least two of the plurality of flow elements comprise different flow environments for the fluid.

The rheometer of the present invention thus enables the flow characteristics of a fluid to be determined because the at least two flow environments provide two independent changes in fluid pressure and thus two distinct points on the flow curve which characterises the fluid. The rheometer further enables the flow characteristics to be determined at a particular instant, since the pressure drop across each element can be measured substantially simultaneously. Additional flow environments can be included in the circuit to provide further points on the flow curve and thus to provide statistical confidence in the graphical trend of apparent viscosity with mean strain rate. A sufficient number of points also provides statistical confidence in the parameters derived using the Constitutive Equations.

Typically, the rheometer may be used to determine the rheological properties of fluids such as blood or foodstuffs. For example, the rheometer may be used to measure the clotting rate of blood. Alternatively, the rheometer may be used e.g. to optimise the formulation of foodstuffs, by monitoring the rate of gelling.

Preferably, the circuit comprises a substantially closed circuit.

Preferably, each flow element presents a different flow environment for the fluid compared to other flow elements within the circuit. The duct preferably comprises a plurality of duct sections which are separately arranged to communicate fluid between two flow elements. Preferably, at least one duct section of the plurality of duct sections presents a different cross-sectional area to the flow of fluid than the other sections.

The flow environment for the fluid, and thus the respective flow element, of each of the plurality of flow elements is preferably characterised by a size that is determined by a linear dimension. Preferably, the linear dimension is representative of a cross-section of the flow environment or a separation of the pressure sensing means along a particular flow element, which may comprise the length of the particular flow element, for example.

Preferably, the flow environment of each of the flow elements comprises substantially the same shape and more preferably, the flow environment of each of the flow elements is arranged to present a substantially similar cross-sectional shape to the flow of fluid.

The plurality of flow elements are preferably arranged in the circuit such the size of the elements, as characterised by the linear dimension, varies around the circuit in a pseudo-random manner.

Alternatively, the plurality of flow elements are preferably arranged in the circuit such that the size of each flow element, as characterised by the respective linear dimension, successively increases or decreases around the circuit. In a further alternative, the plurality of flow elements are preferably arranged in the circuit such that the size of each flow element, as characterised by the respective linear dimension, increases and decreases around the circuit. These alternative arrangements of flow elements within the circuit is found to minimise the circuit length that is required to minimise the effect of fluid entry and exit to and from respectively, the circuit.

Preferably, the fluid is passed around the circuit at a controlled volumetric flow rate. The rheometer preferably further comprises a pump for circulating the fluid around the circuit. Preferably, the pump comprises a peristaltic pump.

In certain cases, the rheometer may include a mass exchanger for controlling the composition of the fluid being circulated around the circuit. This allows the rheological properties of the fluid to be determined as a function of composition.

For example, in the case that the rheometer is used to determine the rheological properties of blood, the mass exchanger may be adapted to regulate the concentrations of selected gasses in the circulating blood. In this way, the rheometer may be used to analyse the influence of blood gas composition on e.g. the rate of clotting. This would allow the biocompatibility of different materials with blood to be tested over a range of blood gas compositions (including e.g. arterial or venous compositions). Similarly, the effect of anticoagulants could be tested over a range of blood gas compositions.

The mass exchanger may be a dialyser, to control the concentration of, e.g. urea, within the blood sample being tested.

In the case that the rheometer is used for testing foodstuffs, the mass exchanger may be used to control the formulation of the foodstuff, so as to allow the influence of the formulation on the gelling rate to be determined.

The circuit is preferably removably coupled within the rheometer. It is envisaged that the circuit may be fabricated as a single extrusion so that it may be removed from the rheometer and disposed with clinical waste. Importantly, the single extrusion minimises any surface irregularities of the joins between the flow elements and the ducts, which would otherwise exist and which would otherwise promote blood clotting. However, it is also desirable to investigate the incremental effect of the shape and materials on factors such as the clotting rate. Accordingly, at least one of the plurality of flow elements is preferably removably coupled within the circuit.

Preferably, the circuit is adapted to receive a lining on a surface of the circuit which is arranged to contact the fluid. Preferably, the lining comprises a test material which is applied as a coating to the surface.

The flow environment of the at least one flow element which is arranged to be removably coupled within the circuit is preferably arranged to receive a lining or further lining. Preferably, the lining or further lining comprises a test material which is applied as a coating to the surface of the flow environment of the at least one flow element, which is arranged to contact the fluid.

Preferably, at least one of the plurality of flow elements comprise a tube.

Preferably, the pressure sensing means comprises a pressure sensor and more preferably a non-invasive pressure sensor, disposed at an upstream position and a downstream position of each flow element.

In accordance with the present invention as seen from a second aspect, there is provided a method of determining flow characteristics of a fluid, the method comprising the steps of:
passing the fluid through a circuit comprising a duct and a plurality of flow elements arranged in fluid communication with the duct, and,
determining the change in fluid pressure between an upstream position and a downstream position of each flow element.

Preferably, the method further comprises the step of passing the fluid around the circuit at a controlled volumetric flow rate.

The method further comprises relating the determined fluid pressure change to a stress and/or strain of the fluid.

An embodiment of the present invention will now be described by way of example only and with reference to the accompanying drawings, in which:

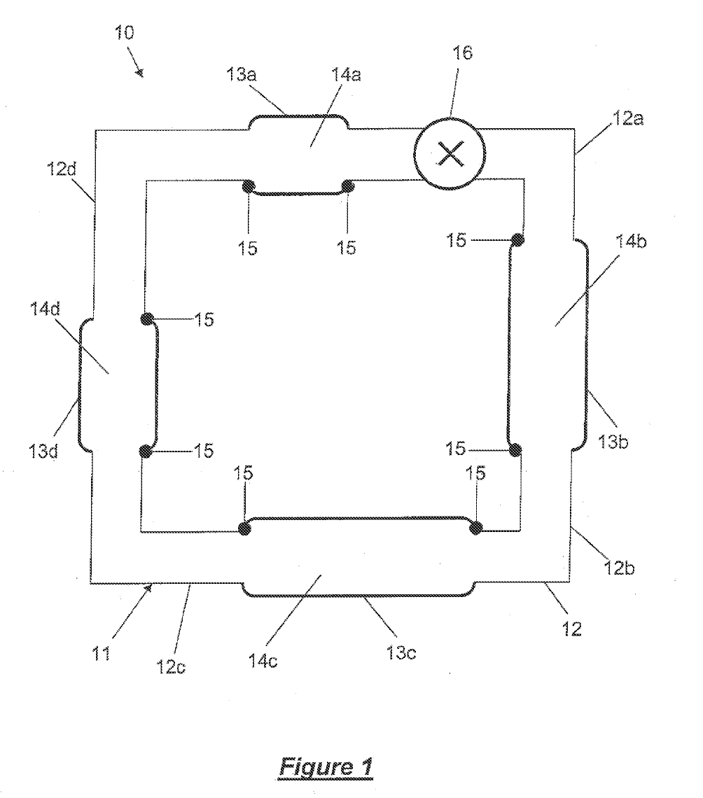

FIG. 1 is a schematic illustration of the rheometer according to an embodiment of the present invention; and,

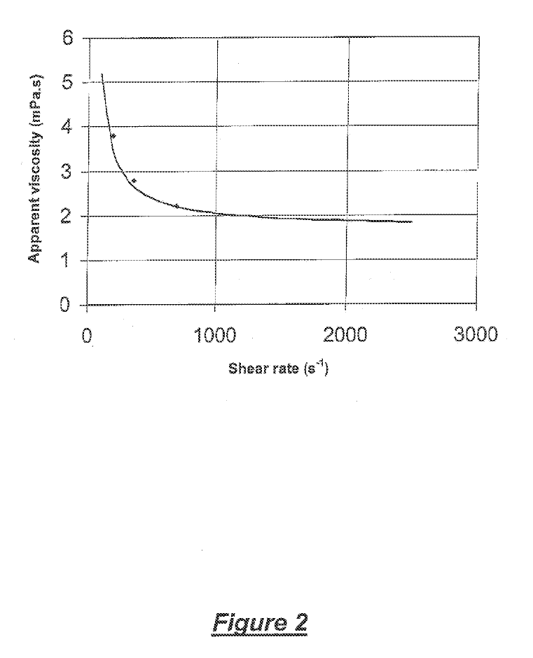

FIG. 2 is a graphical representation of the apparent viscosity against shear rate for a typical non-gelling, non-Newtonian fluid.

Referring to FIG. 1 of the drawings, there is illustrated a rheometer 10 according to an embodiment of the present invention. The rheometer 10 comprises a fluid circuit 11 having an inlet (not shown) for admitting the fluid whose rheological properties are to be determined into the circuit 11 and an outlet (not shown) to enable the fluid to pass out from the circuit 11. The circuit 11 may be removably coupled within the rheometer 10 and comprises a substantially closed circuit so that the fluid under investigation can be recycled around the circuit 11, as required. The removable nature of the circuit enables a further circuit (not shown) to be quickly and easily replaced within the rheometer 10 so that the rheometer 10 can be readily used with another fluid, for example a different blood sample, without having to first clean the circuit 11. In this respect, it is envisaged that the circuit may be made disposable.

The circuit 11 comprises a duct 12 which is arranged to communicate the fluid around the circuit 11 and between several flow elements 13a-d, at least one of which may be removably positionable within the circuit 11. Each flow element 13a-d comprises a flow passage 14a-d which extends through the respective element 13a-d and which is arranged in fluid communication with the duct 12. Accordingly, each flow passage 14a-d is arranged to convey fluid along the respective flow element 13a-d so that fluid is permitted to flow around the circuit 11. The or each flow element 13a-d may comprise a tube formed from extruded or moulded polymer, for example, or some other flow element 13a-d which is arranged to generate a particular flow pattern for the fluid in passing through the element 13a-d. The elements 13a-d are further arranged in a series configuration such that the fluid must pass through each element 13a-d in moving around the circuit 11.

The flow passage 14a-d of each flow element 13a-d is characterised by a hydraulic mean diameter which is proportional to the internal cross-sectional area of the element 13a-d and inversely proportional to the perimeter of that area. Each passage 14a-d may be further characterised by a length of the passage 14a-d.

The rheometer 10 further comprises a pressure sensor 15, such as a non-invasive pressure sensor, as disclosed in UK Patent Application No. 090727.1, positioned at an upstream position and a downstream position of each flow element 13a-d, which are arranged to determine a change in fluid pressure as the fluid moves along the respective element 13a-d or a selected length of the element 13a-d. The rheometer 10 further comprises a pump 16, such as a peristaltic pump, for circulating the fluid around the circuit 11.

In use, the rheometer 10 according to an embodiment of the present invention is first calibrated, at a controlled temperature, using a Newtonian fluid of accurately known viscosity. During this calibration, the fluid is pumped around the circuit 11 at a controlled volumetric flow rate. The effective mean diameters of the components can then be calculated from standard viscous flow formulae. After calibration, the fluid to be tested is pumped around the circuit 11 at a fixed volumetric flow rate. The apparent viscosity (μ) of the test fluid in each flow element 13a-d is then computed from the ratio of measured pressure drop ΔP, to the calibration pressure drop ΔP_{c} obtained during the calibration stage, using the relationship:

μ=μ_{c}(ΔPG_{c})/(ΔP_{c} G) (1)

where μ_{c} is the viscosity of the calibration fluid and G_{c} and G are the volumetric flow rate of the calibration fluid and the test fluid, respectively. The hydraulic mean diameter of the flow elements 13a-d and the volumetric flow rate of fluid around the circuit 11 is chosen to ensure that the flow of fluid within each element 13a-d is substantially laminar. In addition, the flow passage 14a-d of each element 13a-d is arranged to have a different mean diameter to that of the other elements 13a-d to ensure the mean strain rate is different in each element 13a-d. Accordingly, the measured pressure drop across each element 13a-d can be measured and the apparent viscosity can be computed from the above formula. If the fluid is non-Newtonian, the apparent viscosity would be expected to differ in each element 13a-d so that each element 13a-d provides a distinct point in the graphic representation of apparent viscosity versus strain rate. In this respect, the number of flow elements 13a-d is chosen to provide an array of points in the graphic representation of viscosity against stress/strain, in order to determine a suitable relationship between the apparent fluid viscosity and strain rate.

In order to compensate for possible entry and exits effects of the passage of fluid into and out of the circuit 11, respectively, the flow elements 13a-d may be placed in a apparent random sequence of hydraulic mean diameters (equivalent to randomizing a sequence of experiments in time) or two sequences can be chosen, one in which the hydraulic mean diameters of the flow elements 13a-d successively increase around the circuit 11 and the other in which the hydraulic mean diameters of the flow elements 13a-d successively decrease around the circuit 11. Moreover, the increasing/decreasing diameters can be incorporated into a single circuit 11, or can be studied in two successive passes of the fluid through the circuit 11. In order to preserve this successive increase and/or decrease in diameter, the cross-sectional area of the sections 12a-d of duct 12, which are disposed between the flow elements 13a-d, are also arranged to successively increase and/or decrease around the circuit 11.

In accordance with a first embodiment of the rheometer 10 of the present invention, each of the elements 13a-d are chosen to comprise the same material and the surface defining the flow passage 14a-d of each element 13a-d is exposed to the same surface treatment. In addition, the flow passage 14a-d of each element 13a-d respectively, is chosen to comprise a substantially uniform, cross-section, which is of a geometrically similar shape to the other flow elements 13a-d. The elements 13a-d are formed of the same material and exposed to the same surface treatment and finish (both in chemical composition and surface roughness) to mitigate any dependence of fluid stress and/or strain on the surface properties of the materials contacting the fluid. Each element 13a-d is arranged to provide one point on an apparent viscosity versus mean strain rate curve, at one point in time. Accordingly, where the rheological properties of the fluid vary with time, this embodiment enables a new apparent viscosity versus mean strain rate to be derived at each convenient increment of time. In this way, the rate of change of rheological properties of the fluid can be derived.

The rheometer 10 according to a second embodiment of the present invention can also be used to derive the rheological properties of gelling fluids as a function of time and as a function of the material and/or surface topography over which it flows. The characterising parameter, namely the gel point, is that point at which a solid phase forms which will not flow without applying a finite stress greater than zero.

In characterising the rheological properties of gelling fluids, the residence time of the fluid within the circuit 11 is arranged to be a small fraction of the gelling time, so that the amount of gelling between one flow element 13a-d and the next becomes negligible. In this case, all but one of the flow elements 13a-d are chosen to comprise a substantially similar flow passage 14a-d having a substantially uniform, cross-sectional shape. The “similar” flow elements 13a-c for example, are further chosen to comprise the same material, with the same surface treatment and finish. The non-similar element 13d for example, then enables the effect of the material, cross-sectional shape and surface finish on gelling rate, to be derived as a function of material, shape or surface finish, respectively.

For example, with fluids such as blood, for which the gel point depends on the surface characteristics of the materials that it contacts, the gel point can be determined as a function of the surface of the flow elements 13a-d which define the flow passages 14a-d. The rheometer 10 according to an embodiment of the present invention can thus be used to determine the blood compatibility of certain materials by coating the surface of the flow passage 14a-d of each the elements 13a-d with the chemical or biochemical material under test. Alternatively, if the whole circuit 11 gives rise to very slow clotting, a further element (not shown) which is made of the test material and which comprises the test surface treatment, may be introduced. Accordingly, the parameters in the constitutive equations describing the rheological properties can be derived at that instant and as the test progresses, the parameters can be calculated and the values of the parameters can be derived as a function of time, to determine the gel point.

As an example, the constitutive equation describing a simple non-Newtonian fluid may be expressed as:

(dF/dA)−C=μ(dv/dx) for (dF/dA)>C (2)

where (dF/dA) is the force per unit area, namely the stress and (dv/dx) is the velocity gradient, namely local strain rate. The parameter C is the critical stress below which there is no fluid flow and the material behaves as a solid. Over a period of time, the value of the viscosity changes and at the gel point, the parameter C becomes non-zero. The gel point can thus be determined by extrapolating or interpolating the changing values of the parameters in the constitutive equations to determine the time at which the parameter C becomes non-zero.

For non-homogenous fluids that show stratification dependent on the flow pattern, such as blood, flow elements exhibiting particular flow patterns can be placed within the circuit 11 to investigate the flow characteristics of the fluid as a function of the flow pattern. For example, in order to optimize the design of a mass exchanger (not shown) the geometry of one or more of the flow elements 13a-d may be arranged to exhibit the flow pattern of the mass exchanger (not shown) of interest. The rheometer 10 according to the embodiment of the present invention thus provides a tool for optimizing materials, surface finish and physical design for a particular fluid.

The gelling characteristics of some fluids are also found to depend on chemical changes in the fluid. For example, heparin is a more effective anticoagulant for venous (deoxygenated) blood than for arterial (oxygenated) blood. Conversely, aspirin is a more effective anticoagulant for arterial than for venous blood. The rheometer 10 according to an embodiment of the present invention provides the means to simultaneously control blood gas concentrations while measuring rheological properties. For example, in characterising the rheological properties of blood and other fluids which have properties dependent on dissolved species, the flow elements 13a-d can be designed to control partial pressures or concentrations of components in the fluid. Each flow element 13a-d of the rheometer 10 may comprise a mass exchanger (not shown), for example, which ensures that blood gas concentrations are controlled, or even a simple gas permeable tube (not shown) with a controlled atmosphere around the tube (not shown).

The rheometer 10 according to an embodiment of the present invention was used to determine the rheological properties of a non-Newtonian fluid, namely a mixture of water and 1000 ppm polyacrylamide. The flow elements 13 of the rheometer 10 comprised 3 tubes, each having a different internal diameter. The fluid was maintained at a temperature of 25° C. and circulated at a constant volumetric flow rate of 60 ml/min around the circuit 11 using the pump 16. The results of the test are illustrated in FIG. 2 of the drawings. FIG. 2 clearly shows the three points obtained at a single instant, at a single volumetric flow rate. The results confirm that the rheometer 10 according to the present invention is thus capable of providing a set of points at one instant that would otherwise require an extensive set of experiments at differing volumetric flow rates using an instrument such as a capillary rheometer. The ability to capture the complete apparent viscosity versus strain rate curve (and hence the parameters of the constitutive equation) at one point in time enables the time variation of the curve to be determined for a gelling fluid, such as blood.

From the foregoing therefore, it is evident that the rheometer of the present invention provides a simple yet versatile means of characterising the rheological properties of fluids.

1. A rheometer for determining flow characteristics of a fluid, the rheometer comprising a substantially closed circuit in which the fluid is arranged to flow, the circuit comprising a duct and a plurality of flow elements,
each of the plurality of flow elements comprising a flow environment arranged in fluid communication with the duct, each flow environment being arranged to convey fluid from an upstream position to a downstream position of the respective flow element,
the rheometer further comprising pressure sensing means arranged to determine fluid pressure at the upstream position and the downstream position of each of the plurality of flow elements, wherein,
at least two of the plurality of flow elements comprise different flow environments for the fluid.

2. A rheometer according to claim 1, wherein each flow element presents a different flow environment for the fluid compared to other flow elements within the circuit.

3. A rheometer according to claim 1, wherein the duct comprises a plurality of duct sections which are separately arranged to communicate fluid between two flow elements.

4. A rheometer according to claim 3, wherein at least one duct section of the plurality of duct sections presents a different cross-sectional area to the flow of fluid than the other sections.

5. A rheometer according to claim 1, wherein the flow environment for the fluid and thus the respective flow element, of each of the plurality of flow elements is characterised by a size that is determined by a linear dimension.

6. A rheometer according to claim 5, wherein the linear dimension is representative of a cross-section of the flow environment or a separation of the pressure sensing means along a particular flow element.

7. A rheometer according to claim 1, wherein the flow environment of each of the flow elements comprises substantially the same shape.

8. A rheometer according to claim 1, wherein the flow environment of each of the flow elements is arranged to present a substantially similar cross-sectional shape to the flow of fluid.

9. A rheometer according to claims 5, wherein the plurality of flow elements are arranged in the circuit such the size of the elements, as characterised by the linear dimension, varies around the circuit in a pseudo-random manner.

10. A rheometer according to claims 5, wherein the plurality of flow elements are arranged in the circuit such that the size of each flow element, as characterised by the respective linear dimension, successively increases or decreases around the circuit.

11. A rheometer according to claims 5, wherein the plurality of flow elements are arranged in the circuit such that the size of each flow element, as characterised by the respective linear dimension, increases and decreases around the circuit.

12. A rheometer according to any preceding claim, wherein the fluid is passed around the circuit at a controlled volumetric flow rate.

13. A rheometer according to claim 1, further comprising a pump for circulating the fluid around the circuit.

14. A rheometer according to claim 13, wherein the pump comprises a peristaltic pump.

15. A rheometer according to claim 1, including a mass exchanger that is adapted to control the composition of fluid flowing within the circuit.

16. A rheometer according to claim 1, wherein the circuit is removably coupled within the rheometer.

17. A rheometer according to claim 1, wherein at least one of the plurality of flow elements is removably coupled within the circuit.

18. A rheometer according to claim 1, wherein the circuit is adapted to receive a lining on a surface of the circuit which is arranged to contact the fluid.

19. A rheometer according to claim 18, wherein the lining comprises a test material which is applied as a coating to the surface.

20. A rheometer according to any of claims 17, wherein the flow environment of the at least one flow element which is arranged to be removably coupled within the circuit is arranged to receive a lining or further lining.

21. A rheometer according to claim 20, wherein the lining or further lining comprises a test material which is applied as a coating to the surface of the flow environment of the at least one flow element, which is arranged to contact the fluid.

22. A rheometer according to any preceding claim, wherein at least one of the plurality of flow elements comprise a tube.

23. A rheometer according to claim 1, wherein the pressure sensing means comprises a pressure sensor disposed at an upstream position and a downstream position of each flow element.

24. A rheometer according to claim 23, wherein the pressure sensor comprises a non-invasive pressure sensor.

25. A method of determining flow characteristics of a fluid, the method comprising the steps of:
passing the fluid through a substantially closed circuit comprising a duct and a plurality of flow elements arranged in fluid communication with the duct, and,
determining the change in fluid pressure between an upstream position and a downstream position of each flow element.

26. A method according to claim 25, further comprising the step of passing the fluid around the circuit at a controlled volumetric flow rate.

27. A method according to claim 25, further comprising relating the determined fluid pressure change to a stress and/or strain of the fluid.

28. (canceled)

29. (canceled)
